(19) United States
(12) Patent Application Publication
(10) Pub. No.: US 2026/0235137 A1
(43) Pub. Date: Aug. 13, 2026

(54) SEALING ARRANGEMENT, PUMP AND METHOD

(71) Applicant: AALTO UNIVERSITY FOUNDATION SR, Aalto (FI)

(72) Inventors: Petteri HAVERINEN, Aalto (FI); Onni LEUTONEN, Aalto (FI); Jaakko MAJURI, Aalto (FI); Mikael MIETTINEN, Aalto (FI); Valtteri VAINIO, Aalto (FI); Raine VIITALA, Aalto (FI)

(73) Assignee: AALTO UNIVERSITY FOUNDATION SR, Aalto (FI)

(21) Appl. No.: 19/475,011

(22) PCT Filed: Apr. 4, 2024
(86) PCT No.: PCT/FI2024/050156

§ 371 Date: Oct. 13, 2025

(30) Foreign Application Priority Data
Apr. 12, 2023 (FI) 20237066

(51) Int. Cl. F04D 29/12

(52) U.S. Cl. CPC F04D 29/128

(57) ABSTRACT

A sealing arrangement for sealing a liquid-pumping pump, includes a first annular seal (e.g., porous material), arranged around a shaft of the pump with a sealing surface (e.g., porous material) in a first plane substantially perpendicular relative to a pump shaft rotation axis. A gas passage conveys gas to the seal. A support frame is provided for the first seal onto which the first annular seal is mounted. An opposing surface for the first seal is arranged against the sealing surface of the first seal. At least one of the support frame for the first seal and the opposing surface for the first seal is arranged to be floating in such a way that it is able to move relative to a body of the pump, whereby the sealing arrangement is capable of compensating for position errors of the pump shaft or body.

### BACKGROUND

The invention relates to a sealing arrangement for sealing a liquid-pumping pump, i.e. a liquid pump.

The invention further relates to a liquid pump comprising
the sealing arrangement.

The invention further relates to a method for sealing a liquid pump.

Mechanical end face seals are used for sealing liquid-pumping process pumps. The operating principle of a mechanical end face seal is based on two opposing, very planar surfaces. The rotors of process pumps pumping liquid, such as water, are sealed by liquid-lubricated, such as water-lubricated, precision-mechanical seal elements. The materials of the seal elements are worn in the wearing operating environment. The seal surfaces are usually made of silicon carbide, which is the optimal material for this environment. The operation of the seal elements is based on two, polished planar surfaces pressed against each other. Sealing is done by means of a pressurized water-filled chamber in which the liquid pressure is higher than the process pressure. This pressure difference between the seal chamber and the environment causes leakage of the lubricating liquid through the seal on the one hand to the environment, and on the other hand to the process. The liquid is needed to lubricate the seal surfaces, but it leaks outside the pump chamber, whereby replacement liquid has be fed to replace it and the leaked liquid has to be collected.

### BRIEF DESCRIPTION

The sealing arrangement, the liquid pump and the method according to the invention are characterized by the features disclosed in the independent claims. Other embodiments of the invention are characterized by the features disclosed in other claims.

Inventive embodiments are also disclosed in the description and the drawings of this application. The inventive content of the application may also be defined in a way differing from the claims presented hereinafter. The inventive content may also be formed of several separate inventions, especially if the invention is considered in the light of the expressed or implicit subtasks or in terms of the obtained benefits or groups of benefits. Some of the features of the claims presented hereinafter may thus be unnecessary for the separate inventive ideas. The features of different embodiments of the invention may be applied in connection with other embodiments within the scope of the basic inventive idea.

The idea of the sealing arrangement intended for sealing a liquid pump according to the invention is that it comprises
a first annular seal comprising porous material
which seal is arrangeable around a shaft of said pump in such a way that
a sealing surface of the first seal is in a first plane, which plane is at least substantially perpendicular relative to a pump shaft rotation axis, and that the sealing arrangement comprises
gas passages for conveying gas to said seal,
a support frame for the first seal onto which said first annular seal is mounted,
an opposing surface for the first seal, arranged against the sealing surface of the first seal, and that
at least one of the first seal support frame and the first seal opposing surface is arranged to be floating in such a way that it is able to move relative to a body of the pump, whereby the sealing arrangement is capable of compensating for position errors of said pump shaft or body.

The sealing arrangement has a sealing solution based on externally pressurized (aerostatic) sealing. The aerostatic seal is implemented by means of an air bearing made of porous material. The air bearing replaces the generally used water-lubricated mechanical seal. The advantage is that liquid leakages can be replaced with a pure air or gas leakage, whereby contamination of the process liquids and pump environment is prevented. Another advantage is extended life and service time of the seal elements due to reduced friction and wearing enabled by contactless operation.

The idea of the liquid pump according to the invention is that it comprises
the above-mentioned sealing arrangement, and
at least one bearing arranged to a distance from the seals and configured to support a shaft of the pump onto a body of the pump.

The advantage is that no liquid lubricating the bearings is needed in the pump, whereby contamination of the process liquids and leakage of the liquid lubricating the bearings outside the pump chamber are avoided.

The idea of the method according to the invention is to
provide a liquid pump comprising mechanical liquid-lubricated end face seals,
remove said end face seals from said liquid pump, and
install the above-mentioned sealing arrangement in place of said end face seals.

The advantage is that a conventional liquid pump may be converted into a liquid pump in which no liquid lubricating the bearings is needed, whereby contamination of the process liquids and leakage of the liquid lubricating the bearings outside the pump chamber are avoided.

### BRIEF DESCRIPTION OF THE FIGURES

Some embodiments of the invention will be described in more detail in the accompanying drawings, in which

FIG. 1 schematically illustrates one liquid pump and sealing arrangement according to the invention as seen in a direction of a shaft of the pump, and

FIG. 2 schematically illustrates the pump of FIG. 1 as a cross-sectional side view.

In the figures, some embodiments of the invention are illustrated in a simplified manner for the purpose of clarity. Similar parts are indicated with the same reference numbers in the figures.

### DETAILED DESCRIPTION

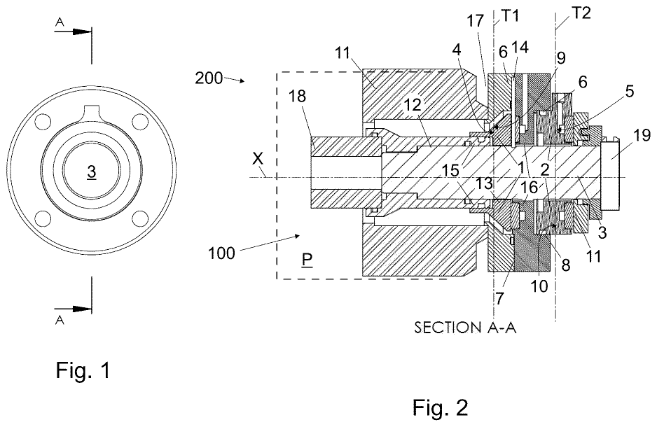

FIG. 1 schematically illustrates one liquid pump and sealing arrangement according to the invention as seen in a direction of a shaft of the pump, and FIG. 2 schematically illustrates the pump of FIG. 1 as a cross-sectional side view.

In one embodiment a sealing arrangement 100 for sealing a liquid-pumping pump, i. e. a liquid pump 200, comprises a first annular seal 1 comprising porous material and a second annular seal 2 comprising porous material, which seals 1, 2 are arrangeable around a shaft 3 of said pump in such a way that a sealing surface 4 of the first seal is in a first plane T1 and correspondingly a sealing surface 5 of the second seal is in a second plane T2. These planes T1, T2 are spaced from each other and at least substantially parallel and at least substantially perpendicular relative to a pump shaft rotation axis X. In one embodiment the planes T1, T2 are parallel and perpendicular relative to the pump shaft rotation axis X.

There may be one, two or several seal surfaces. The advantage of several seal surfaces is to balance the seal forces between the surfaces, so bearings of the shaft will not be stressed due to the seal forces. By applying several seals, the pressure difference between the sides of the seal may be reduced, whereby wear and flow properties of seal gas of the seal may be influenced.

The seal surface may be cylindrical surfaces, conical surfaces, spherical surfaces or some other rotationally symmetrical shapes concentric with the shaft rotation axis.

The sealing arrangement 100 comprises gas passages 6 for conveying gas to said seals 1, 2. The sealing surfaces 4 of the seals comprise porous material, thus enabling the gas to be conveyed through the sealing surface from the gas passages between the seal 1, 2 and an opposing surface 9, 10. In the sealing gap thus formed, the gas forms a lubricating film separating the surfaces from each other. Due to the pressure higher than (or equal to) that of the environment prevailing in the gap the flow is from the seal gap towards the environment. Consequently, the seal gas conveyed to the seal flows out from the gap, preventing the leakage of process fluids through the seal gap.

In one embodiment the seal 1, 2 and the corresponding opposing surface 9, 10 are preloaded against each other by a force element 15, 16, such as a spring, a pneumatic/hydraulic pressure actuator, o-ring pressure or the like. Of the pairs of the seal 1, 2 and the seal opposing surface 8, 9, the rigidity of one member in the axial direction X and in the radial direction is significantly higher than that of the other one, allowing the more rigid member to define the position and the looser—the floating—member to float by the effects of the force element loading and the pressurized gas film located in the seal gap at an optimal sealing gap height. The degrees of freedom for the axial direction and tilt may be distributed between the seal element and the opposing surface in various combinations. The typical sealing gap height is 2-20 μm.

In one embodiment the first annular seal 1 is mounted onto a support frame 7 for the first seal, and said second annular seal 2 is mounted onto a support frame 8 for the second seal.

The sealing arrangement 100 comprises an opposing surface 9 for the first seal, arranged against the sealing surface 4 of the first seal, and an opposing surface 10 for the second seal, arranged against the sealing surface 5 of the second seal.

At least one of the first seal support frame 7 and the first seal opposing surface 9—that is to say, either the seal support frame 7 or the first seal opposing surface 9, or both the support frame 7 and the opposing surface 9—is/are arranged to be floating in such a way that it or they is/are able to move relative to a body 11 of the pump. Further, at least one of the second seal support frame 8 and the second seal opposing surface 10—that is to say, either the support frame 8 for the second seal or the opposing surface 10 for the second seal, or both the support frame 8 and the opposing surface 10—is/are arranged to be floating in such a way that it or they is/are able to move relative to said pump body 11. Due to said floating, the sealing arrangement is capable of compensating for position errors of said pump shaft 3 or body 11 in such a way that the opposite sealing surfaces 4, 5 and corresponding opposing surfaces 9, 10 will be set in the same plane and to a suitable distance relative to each other. Said position errors may be caused for example by manufacturing defects of the pump parts, mistakes in the installation of the pump and/or mistakes made during the use of the pump.

In one embodiment the support frame 7, 8 for at least one seal is arranged to be floating and the seal opposing surface 9, 10 against said support frame is mounted in a non-floating manner.

In one embodiment the support frames 7, 8 for at least two seals are arranged to be floating and the seal opposing surfaces 9, 10 against said support frames are mounted in a non-floating manner.

In one embodiment the opposing surface 9, 10 for at least one seal is arranged to be floating and the seal support frame 7, 8 against said opposing surface is mounted in a non-floating manner.

In one embodiment the opposing surfaces 9, 10 for at least two seals are arranged to be floating and the seal support frames 7, 8 against said opposing surfaces are mounted in a non-floating manner.

In one embodiment the support frame 7 for the first seal is arranged to be floating and the opposing surface 9 for the first seal is mounted in a non-floating manner. In one embodiment the opposing surface 9 for the first seal is arranged to be floating and the support frame 7 for the first seal is mounted in a non-floating manner. In one embodiment the support frame 8 for the second seal is arranged to be floating and the opposing surface 10 for the second seal is mounted in a non-floating manner.

In one embodiment the opposing surface 10 for the second seal is arranged to be floating and the support frame 8 for the second seal is mounted in a non-floating manner.

In one embodiment the opposing surface 9 and the support frame 7 for the first seal are both arranged to be floating, and the opposing surface 10 and the support frame 8 for the second seal are both arranged to be floating.

In one embodiment, such as in FIG. 2, the above-mentioned non-floating mounting is arranged onto the pump body 11.

In one embodiment the above-mentioned non-floating mounting is arranged onto the pump shaft 3.

In one embodiment the support frame 7, 8 or the opposing surface 9, 10 arranged to be floating is capable of moving in a direction of the pump shaft rotation axis X.

In one embodiment the support frame 7, 8 or the opposing surface 9, 10 arranged to be floating is capable of tilting relative to the pump shaft rotation axis X.

In one embodiment the support frame 7, 8 or the opposing surface 9, 10 arranged to be floating is capable of moving in a direction of the pump shaft rotation axis X as well as tilting relative to the pump shaft rotation axis X.

In one embodiment, in a pair formed by the seal and its opposing surface, the opposing surface is immovable in the axial direction X and tilting relative to the axial direction X, and correspondingly the seal is floating in the axial direction X and immovable relative to tilting.

In one embodiment, in a pair formed by the seal and its opposing surface, the seal is immovable in the axial direction X and tilting relative to the axial direction X, and correspondingly the opposing surface is floating in the axial direction X and immovable relative to tilting.

In one embodiment, in a pair formed by the seal and its opposing surface, the opposing surface is immovable in the axial direction X as well as relative to tilting, and correspondingly the seal is floating in the axial direction X as well as relative to tilting.

In one embodiment, in a pair formed by the seal and its opposing surface, the seal is immovable in the axial direction X as well as relative to tilting, and correspondingly the opposing surface is floating in the axial direction X as well as relative to tilting.

It should be noted that in this description the term “immovable” means the governing, i.e. more rigidly supported mounting, and the term “floating” means the adjusting, i.e. more loosely supported mounting (pre) loaded against the governing mounting.

In one embodiment a first force element 15 is provided in the arrangement and arranged to push the sealing surface 4 of the first seal and the opposing surface 9 for the first seal towards each other, and correspondingly a second force element 16 is provided in the arrangement and arranged to push the sealing surface 5 of the second seal and the opposing surface 10 for the second seal towards each other. In one embodiment the force element 15, 16 comprises a spring. The gas to be conveyed to the seals 1, 2, however, keeps said surfaces separated from each other. In one embodiment at a distance of a few micrometres.

In one embodiment the sealing surface 4 of the first seal and the corresponding opposing surface 9 are arranged in an opposite configuration as seen in the axial direction to the sealing surface 5 of the second seal and the corresponding opposing surface 10. Thus, they cancel the forces caused by each other in a direction of the rotation axis X.

In one embodiment the porous material of the seal 1, 2 is carbon-based material, such as graphite.

In one embodiment the porous material of the seal 1, 2 is selected from the group: ceramics, metallic matrix, metallic foam.

According to one idea, the liquid pump 200 comprises the sealing arrangement 100 described in this disclosure, as well as at least one bearing 19 arranged to a distance from the seals 1, 2 to support the pump shaft 3 onto the pump body 11. In one embodiment the bearing is a rolling-element bearing.

In one embodiment the liquid pump 200 is a pump intended for pumping one liquid material. In a second embodiment the liquid pump 200 is a pump intended for pumping a mixture formed by at least two materials. The mixture may be a homogeneous or a heterogeneous mixture. In one embodiment the material to be pumped is a colloidal mixture in which some liquid forms a continuous phase of the mixture. The colloidal mixture may be an emulsion, a slurry or a foam. In one embodiment the liquid pump 200 is a pump intended for pumping water or a mixture in which water forms a continuous phase of the mixture. In one embodiment the liquid pump 200 is a pump intended for pumping a pulp solution or slurry. In a third embodiment the liquid pump 200 is a pump intended for pumping petrochemical liquids and liquid mixtures. In a fourth embodiment the liquid pump 200 is a pump intended for pumping mining industry or mineral processing liquids and liquid mixtures. In a fifth embodiment the liquid pump 200 is a pump intended for pumping mixtures of an industrial process. In one embodiment the liquid pump 200 is a process pump generally used and known in industry, in which mechanical end face seals are used.

In one embodiment the liquid pump 200 comprises at least one intermediate chamber 13 and an intermediate chamber gas passage 14 connected thereto. Via the gas passage a gas, such as air, may be fed to the intermediate chamber. The gas may also be some other gas such as, for example, nitrogen or argon. The gas pressure in the intermediate chamber 13 may be higher than that of the process, or equal to, or lower than that of the process, depending on how the system is balanced. By selecting proper pressures, the operating efficiency of the seal may be optimized in terms of gas consumption and losses.

On the process side of the seal—i.e. on the side of the process chamber P—it is possible to provide recovery of the gas leaking to the process, so that no gas will travel via the pump further to the next process stages.

In the method, the end face seals of a conventional liquid pump comprising mechanical liquid-lubricated end face seals are removed and they are replaced with the sealing arrangement 100 described in this disclosure. In other words, the sealing arrangement 100 is backwards compatible with mechanical end face seal chambers of conventional pumps.

In some cases, the features described in this application may be used as such, regardless of other features. On the other hand, the features described in this application may be combined, if necessary, to form different combinations.

The drawings and the description related thereto are intended to only illustrate the idea of the invention. It will be obvious to one skilled in the art that the invention is not limited to the above-described embodiments in which the invention is illustrated by way of some examples, but many modifications and different applications of the invention are possible within the scope of the inventive idea defined in the claims presented hereinafter.

### REFERENCE SYMBOLS

1 first seal
2 second seal
3 pump shaft
4 sealing surface of first seal
5 sealing surface of second seal
6 gas passage
7 support frame for first seal
8 support frame for second seal
9 opposing surface for first seal
10 opposing surface for second seal
11 pump body
12 support sleeve for seal opposing surface
13 intermediate chamber
14 intermediate chamber gas passage
15 first force element
16 second force element
17 sealing arrangement frame
18 impeller mounting element
19 bearing
100 sealing arrangement
200 liquid pump
P process chamber
T1, T2 first and second plane
X pump shaft rotation axis

1. A sealing arrangement for sealing a liquid-pumping pump, the sealing arrangement comprising:
a first annular seal including porous material,
which seal is arrangeable around a shaft of said pump in such a way that;
a sealing surface comprising-including porous material thereof is in a first plane,
which first plane is at least substantially perpendicular relative to a pump shaft rotation axis;
a gas passage for conveying gas to said seal;
a support frame for the first seal onto which said first annular seal is mounted;
an opposing surface for the first seal, arranged against the sealing surface of the first seal; and wherein:
at least one of the support frame for the first seal and the opposing surface for the first seal is arranged to be floating in such a way that it is able to move relative to a body of the pump, whereby the sealing arrangement is capable of compensating for position errors of said pump shaft or body.

2. The sealing arrangement according to claim 1, comprising:
a second annular seal including porous material, wherein
a sealing surface including porous material of the second seal is in a second plane that is spaced from the first plane and at least substantially parallel relative to the first plane and at least substantially perpendicular relative to the pump shaft rotation axis;
a gas passage for conveying gas to said second seal;
a support frame for the second seal onto which said second annular seal is mounted; and
an opposing surface for the second seal, arranged against the sealing surface of the second seal; wherein
at least one of the support frame for the second seal and the opposing surface for the second seal is arranged to be floating in such a way that it is able to move relative to said pump body.

3. The sealing arrangement according to claim 1, wherein:
the support frame for at least one seal is arranged to be floating; and
the seal opposing surface against said support frame is mounted in a non-floating manner.

4. The sealing arrangement according to claim 3, wherein:
the support frame for at least two seals is arranged to be floating; and
the seal opposing surfaces against said support frames are mounted in a non-floating manner.

5. The sealing arrangement according to claim 1, wherein:
the opposing surface for at least one seal is arranged to be floating; and
the seal support frame against said opposing surface is mounted in a non-floating manner.

6. The sealing arrangement according to claim 5, wherein:
the opposing surfaces for at least two seals are arranged to be floating; and
the seal support frames against said opposing surfaces are mounted in a non-floating manner.

7. The sealing arrangement according to claim 1, wherein:
at least one non-floating mounting is arranged onto the pump body.

8. The sealing arrangement according to claim 1, wherein:
at least one non-floating mounting is arranged onto the pump shaft.

9. The sealing arrangement according to claim 1, wherein:
the support frame or the opposing surface arranged to be floating is capable of moving in a direction of the pump shaft rotation axis.

10. The sealing arrangement according to claim 1, wherein:
the support frame or the opposing surface arranged to be floating is capable of tilting relative to the pump shaft rotation axis.

11. The sealing arrangement according to claim 1, wherein:
the porous material of the seal is graphite.

12. The sealing arrangement according to claim 1, being configured and sized to be backwards compatible with a mechanical end face seal chamber of a pump.

13. A liquid pump in combination with a sealing arrangement which comprises:
a first annular seal including porous material,
which seal is arrangeable around a shaft of said pump in such a way that,
a sealing surface including porous material thereof is in a first plane,
which first plane is at least substantially perpendicular relative to a pump shaft rotation axis;
gas passage for conveying gas to said seal;
a support frame for the first seal onto which said first annular seal is mounted;
an opposing surface for the first seal, arranged against the sealing surface of the first seal; wherein:
least one of the support frame for the first seal and the opposing surface for the first seal is arranged to be floating in such a way that it is able to move relative to a body of the pump, whereby the sealing arrangement is capable of compensating for position errors of said pump shaft or body; and
at least one bearing arranged to a distance from the seals and configured to support a shaft of the pump onto a body of the pump.

14. The liquid pump according to claim 13, configured for pumping a mixture in which gas, solid material and/or other liquid is dispersed in a liquid continuous phase.

15. A method for sealing a liquid pump, the method comprising:
providing a liquid pump comprising mechanical liquid-lubricated end face seals;
removing said end face seals from said liquid pump; and
installing a sealing arrangement in place of said end face seals, wherein the sealing arrangement includes:
a first annular seal including porous material;
which seal is arrangeable around a shaft of said pump in such a way that;
a sealing surface including porous material thereof is in a first plane,
which first plane is at least substantially perpendicular relative to a pump shaft rotation axis, and wherein the sealing arrangement includes:
a gas passage for conveying gas to said seal;
a support frame for the first seal onto which said first annular seal is mounted; and
an opposing surface for the first seal, arranged against the sealing surface of the first seal; wherein:
at least one of the support frame for the first seal and the opposing surface for the first seal is arranged to be floating in such a way that it is able to move relative to a body of the pump, whereby the sealing arrangement is capable of compensating for position errors of the pump shaft or body.
